(19) United States
(12) Patent Application Publication
(10) Pub. No.: US 2006/0289213 A1
(43) Pub. Date: Dec. 28, 2006

(54) HYDROGEN FUEL CELL VEHICLE WITH WIRELESS DIAGNOSTICS

(76) Inventor: Adan R. Cervantes, Marion, IA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/424,399

(22) Filed: Jun. 15, 2006

Related U.S. Application Data
(60) Provisional application No. 60/690,981, filed on Jun. 16, 2005.

(51) Int. Cl. B60L 11/18; H01M 8/04; G05D 11/00

(52) U.S. Cl. 180/65.3; 429/22; 700/286

(57) ABSTRACT

A system for wireless data collection from a hydrogen fuel cell vehicle, comprising: A vehicle that includes a fuel cell and an on-board computer; Transmitter for transmitting data from the on-board computer; and Wireless mechanism for receiving the data.

### CROSS-REFERENCE TO RELATED APPLICATION

The application claims priority under 35 U.S.C. § 119(e) of U.S. Provisional Application No.: 60/690,981, filed on Jun. 16, 2005, which application is incorporated herein by reference.

### FIELD OF THE INVENTION

Embodiments of the invention include systems and methods for wireless data collection from a hydrogen fuel cell vehicle and data transmission to a maintenance data center. Embodiments also include methods and systems for displaying operational and safety information from a hydrogen fuel cell powered vehicle to a driver.

### COPYRIGHT

A portion of the disclosure of this patent document contains material that is subject to copyright protection. The copyright owner has no objection to the facsimile reproduction by anyone of the patent document or the patent disclosure, as it appears in the Patent and trademark Office patent files or records, but otherwise reserves all copyright rights whatsoever. The following notice applies to any software and data as described below and in the drawings that form a part of this document: Adan R. Cervantes Copyright 2006, All Rights Reserved.

### BACKGROUND

Transportation in the United States is powered by oil, which is largely not produced in the United States and which, when burned, produces carbon dioxide and water vapor, among other polluting substances. The United States government, its citizens, and oil companies have accepted pollution producing vehicles as the only devices available for transportation. Indeed, citizen drivers, have played a passive role and have resisted giving up old driving habits. As a result, the driving public has been placed at the mercy of rising fuel prices and unreliable availability of petroleum-based products.

### DESCRIPTION OF THE FIGURES

Description of Figures

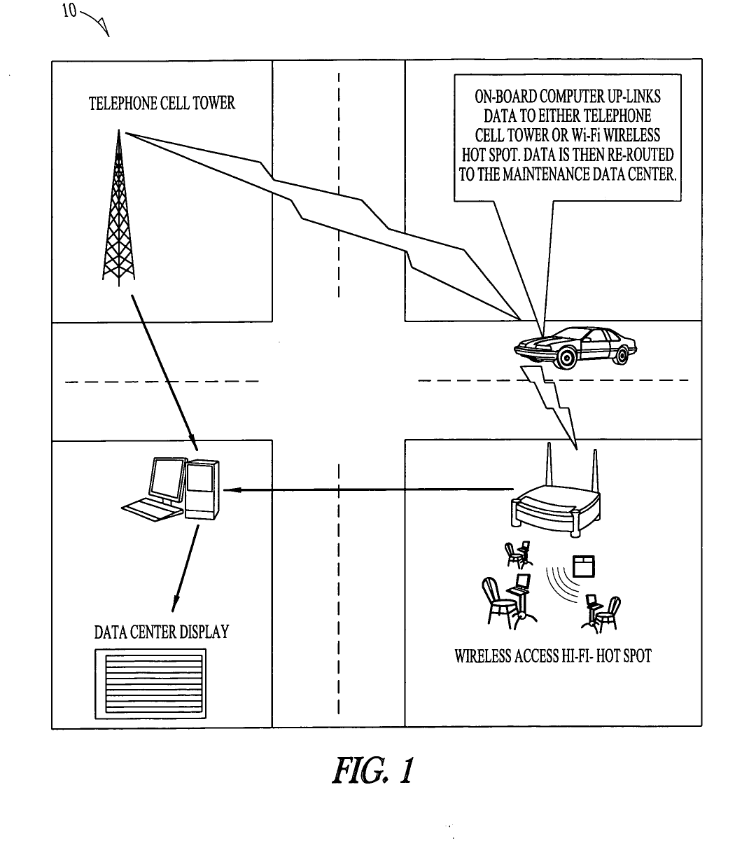

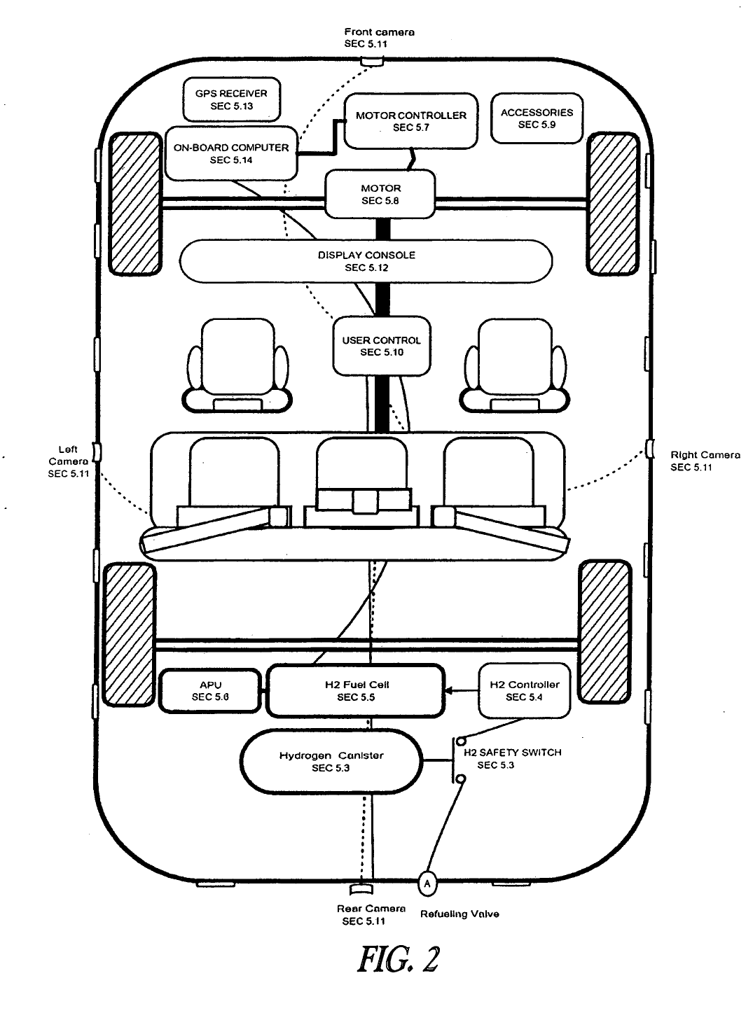

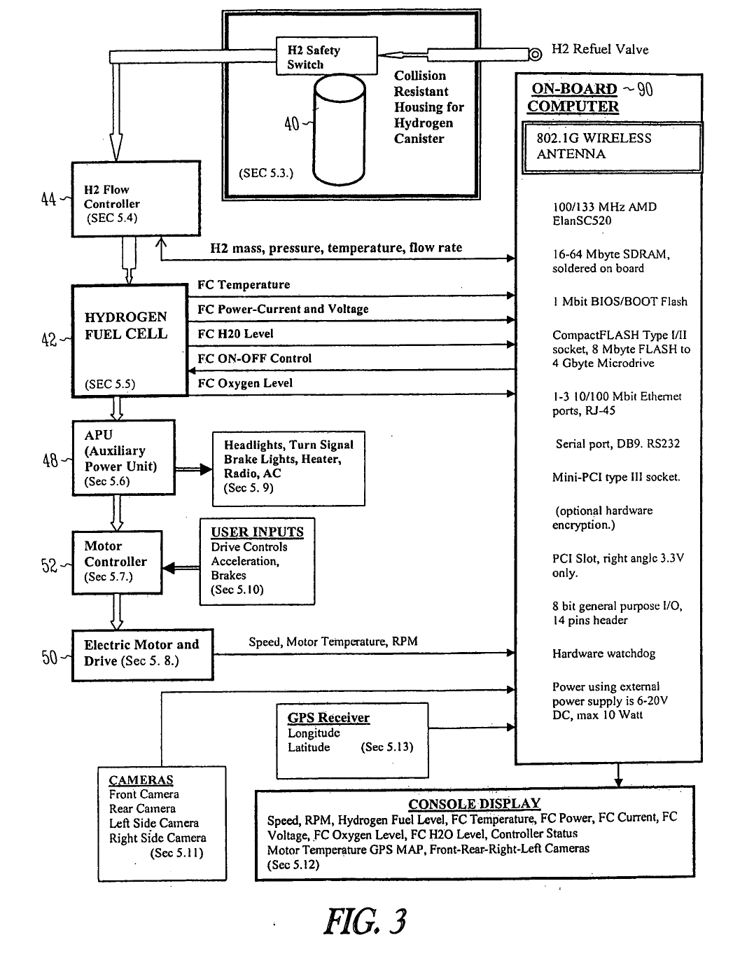

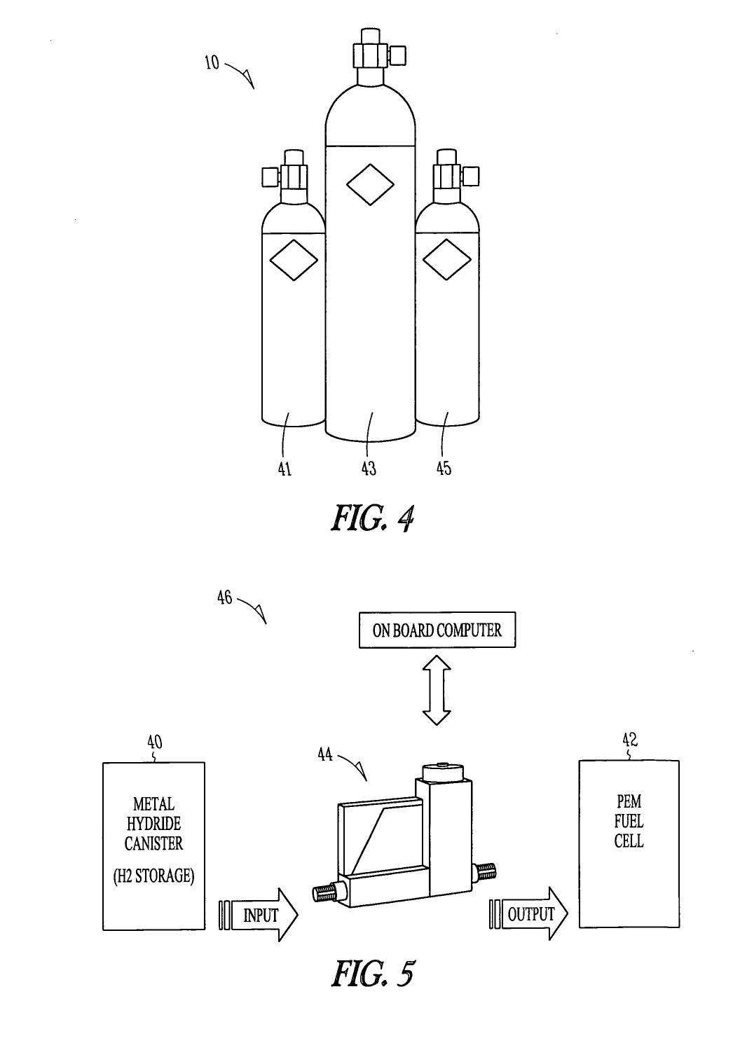

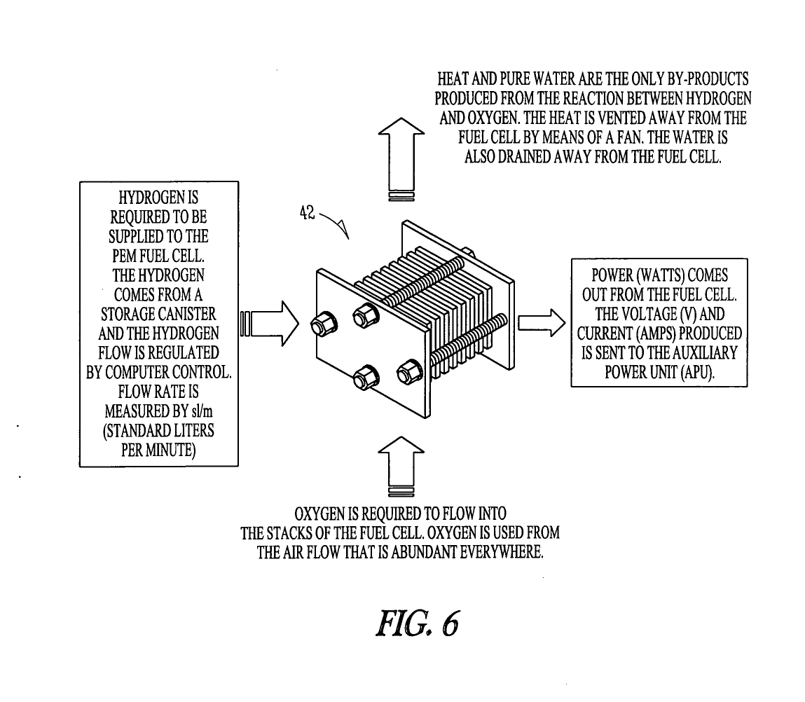

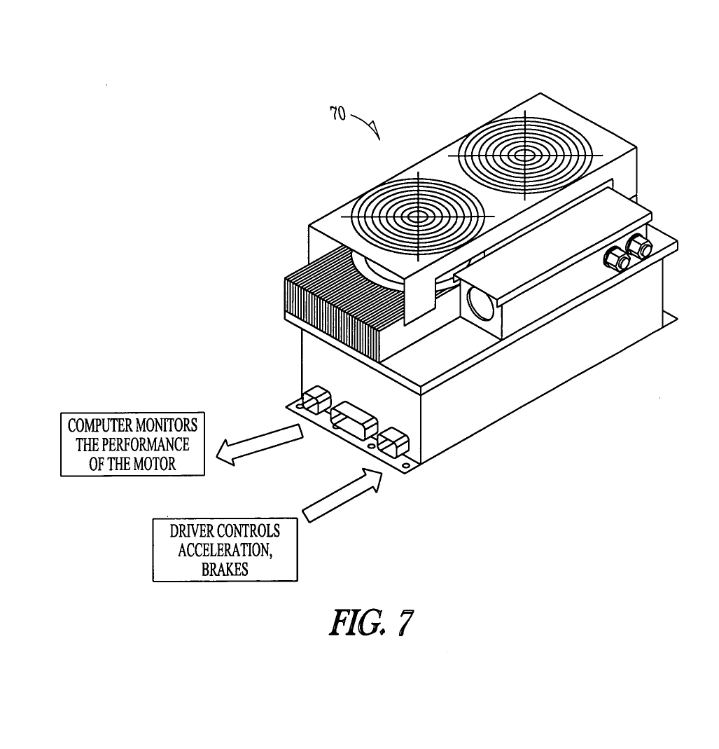

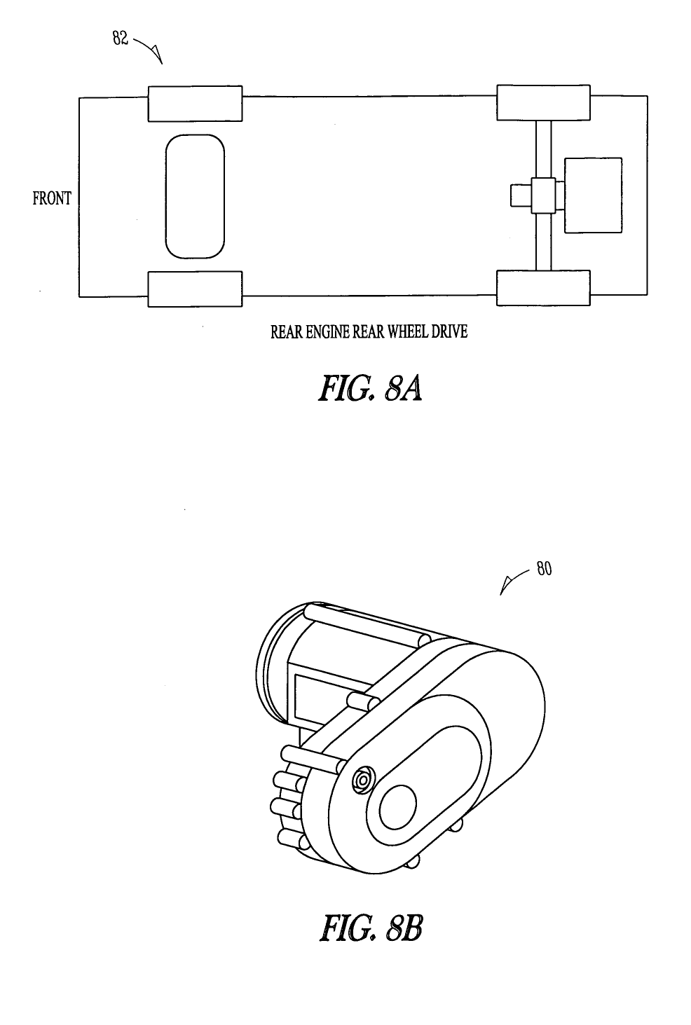

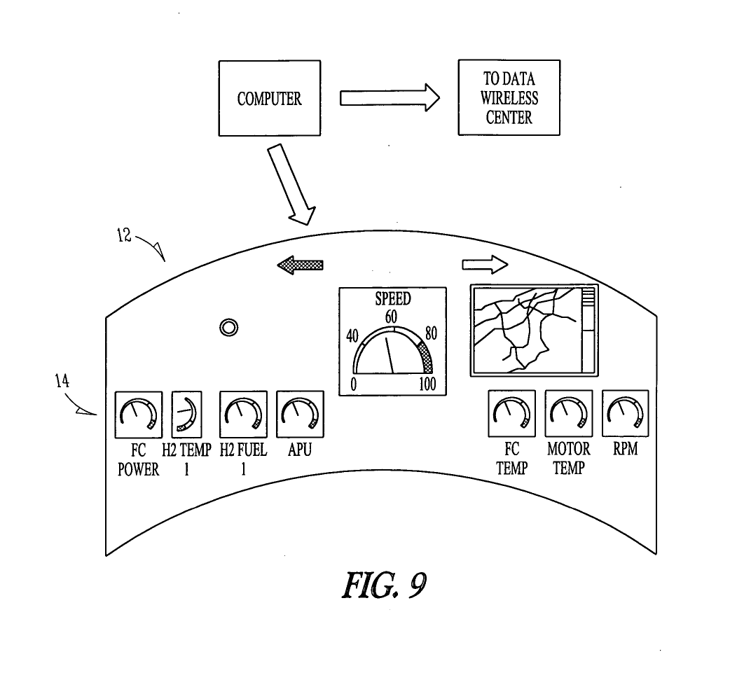

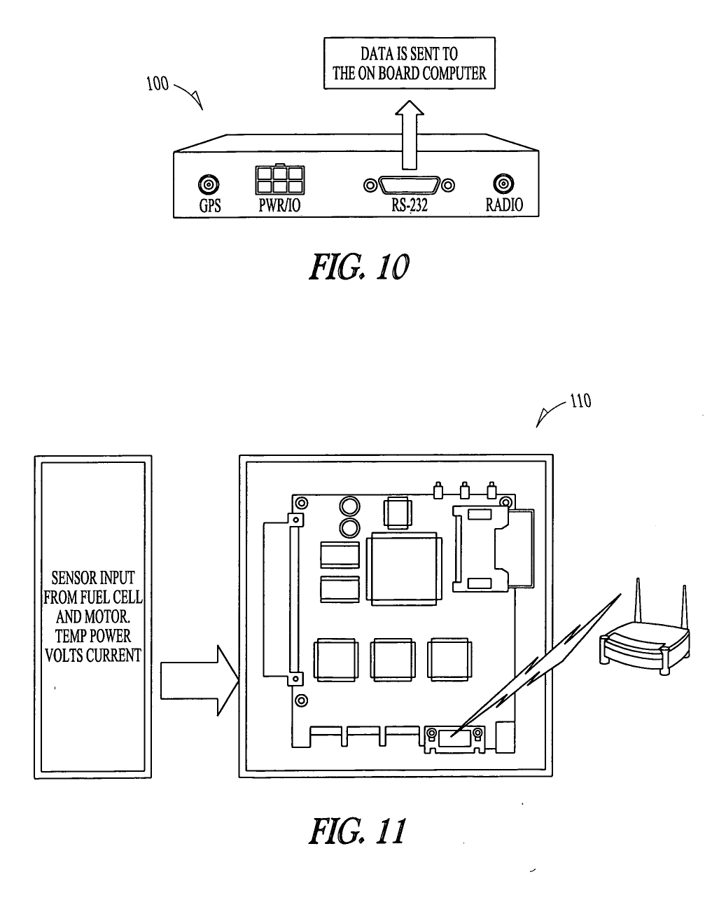

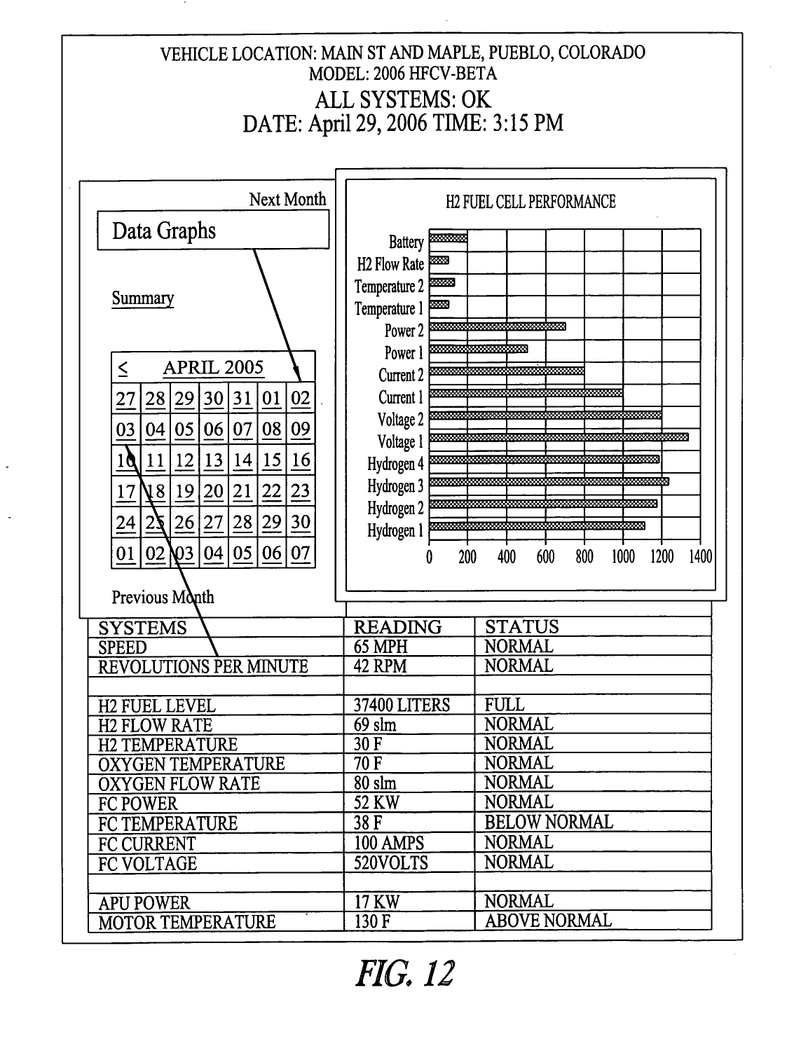

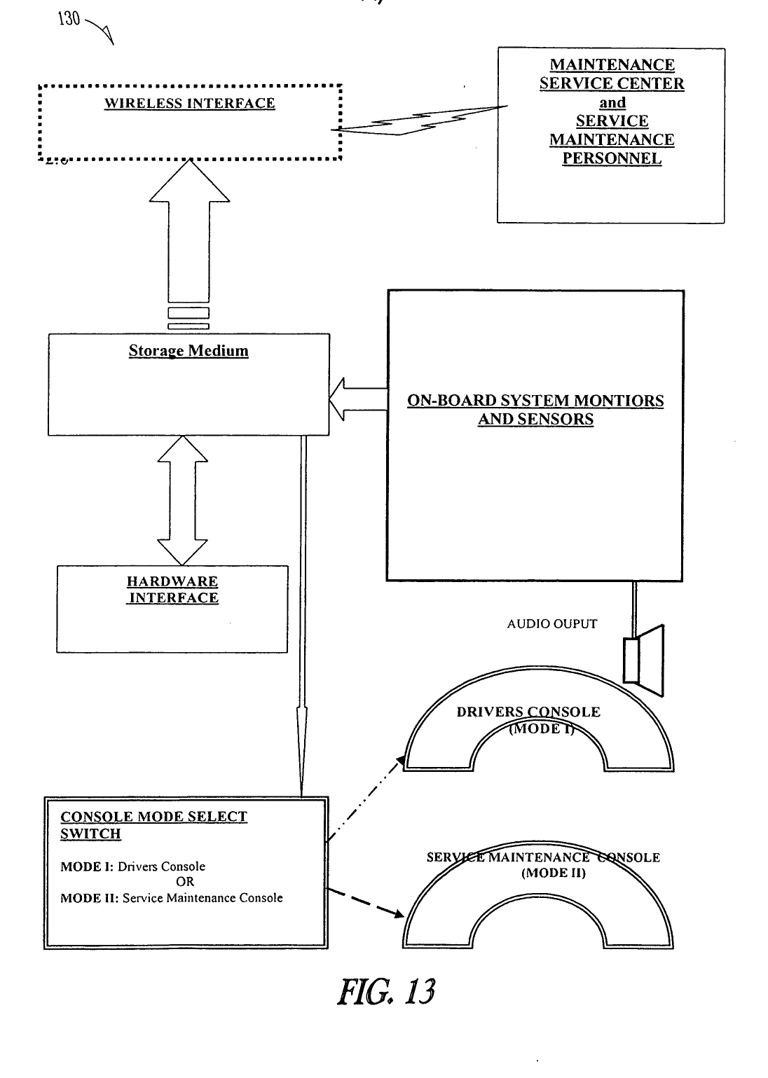

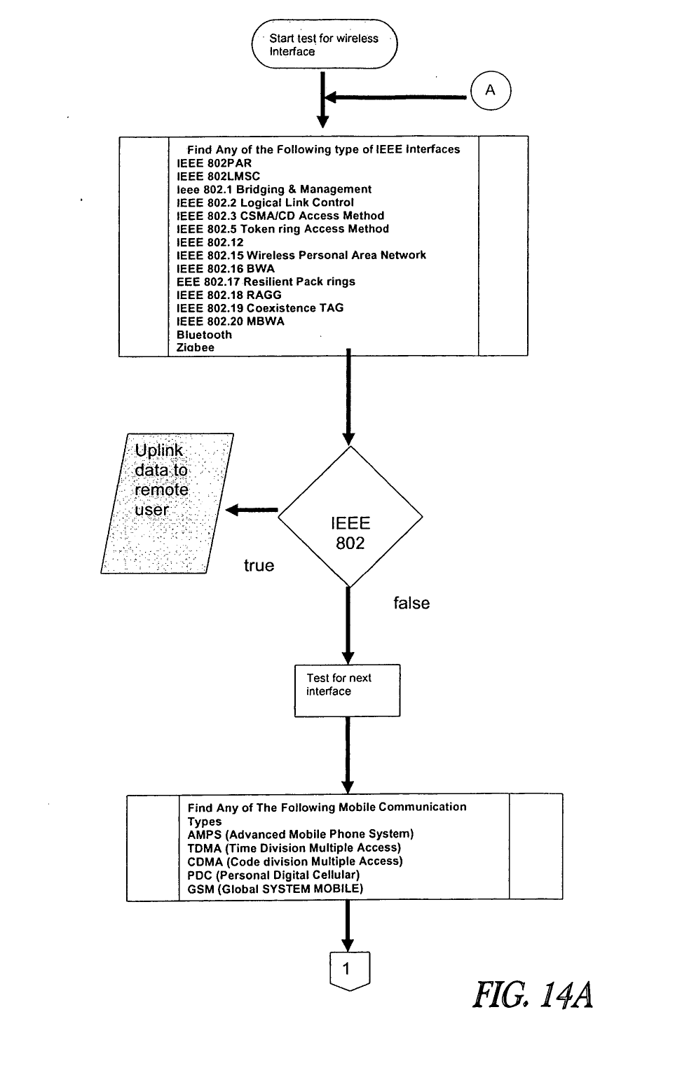

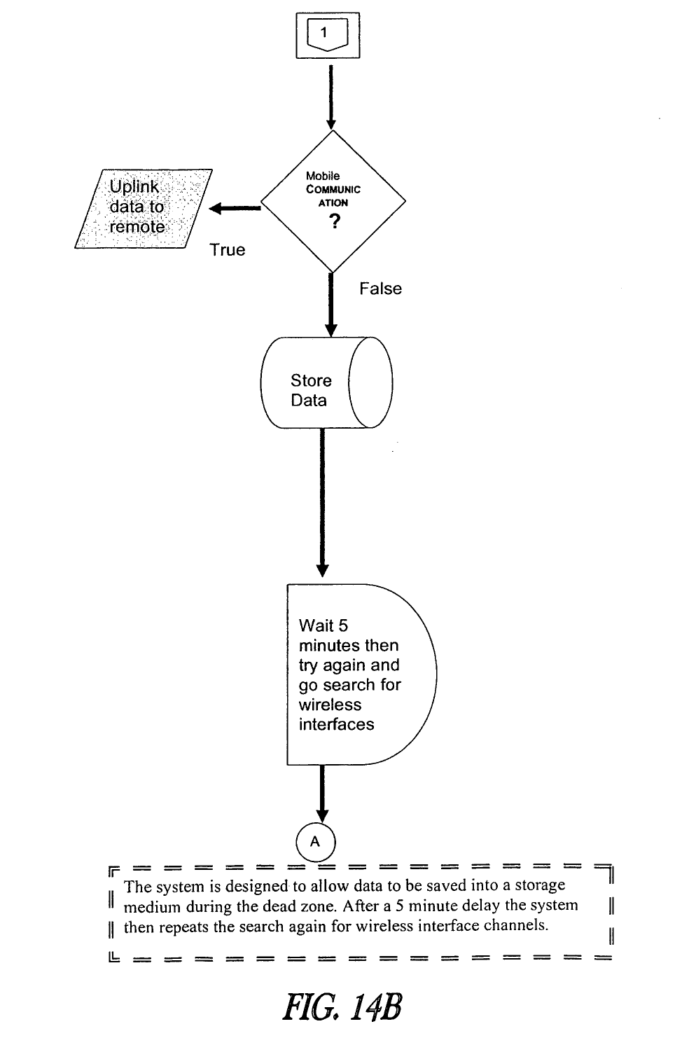

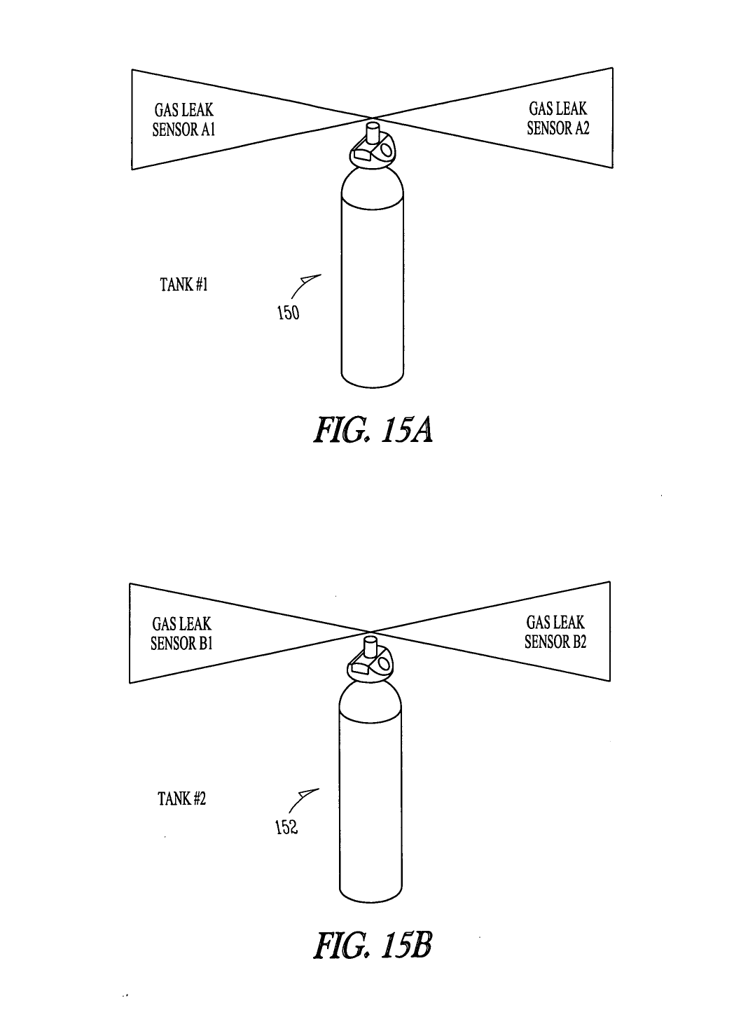

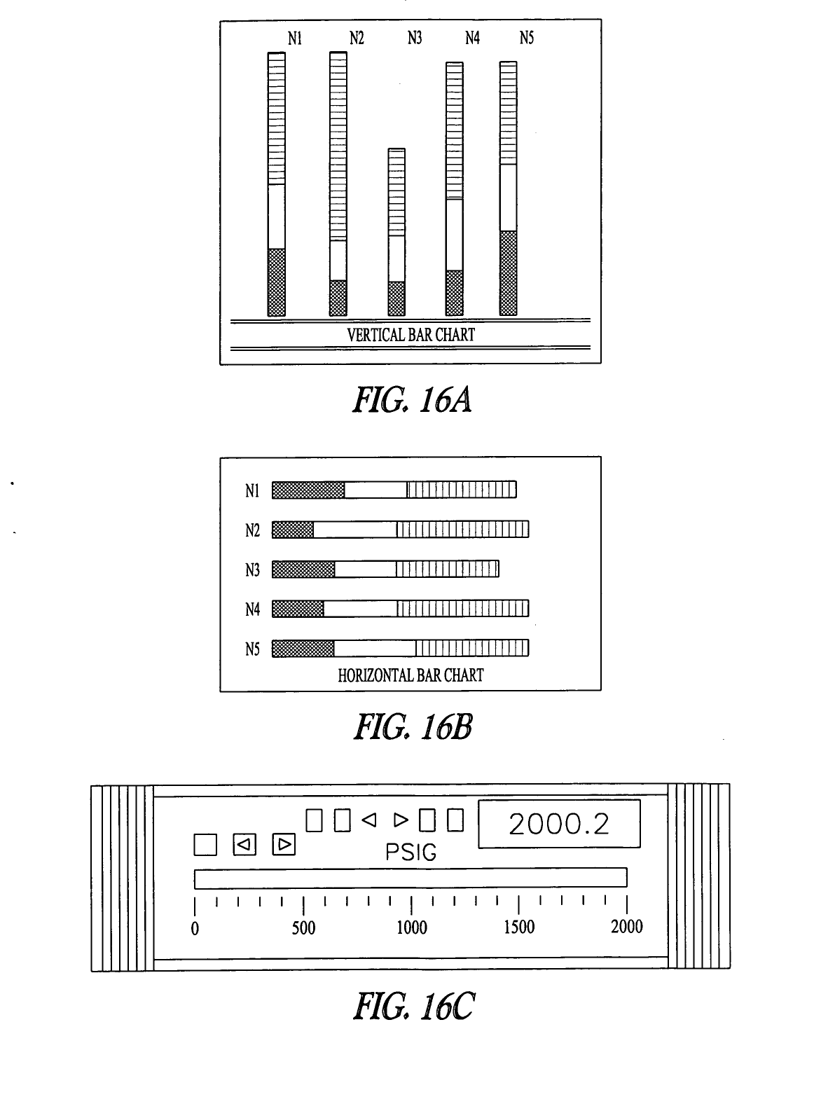

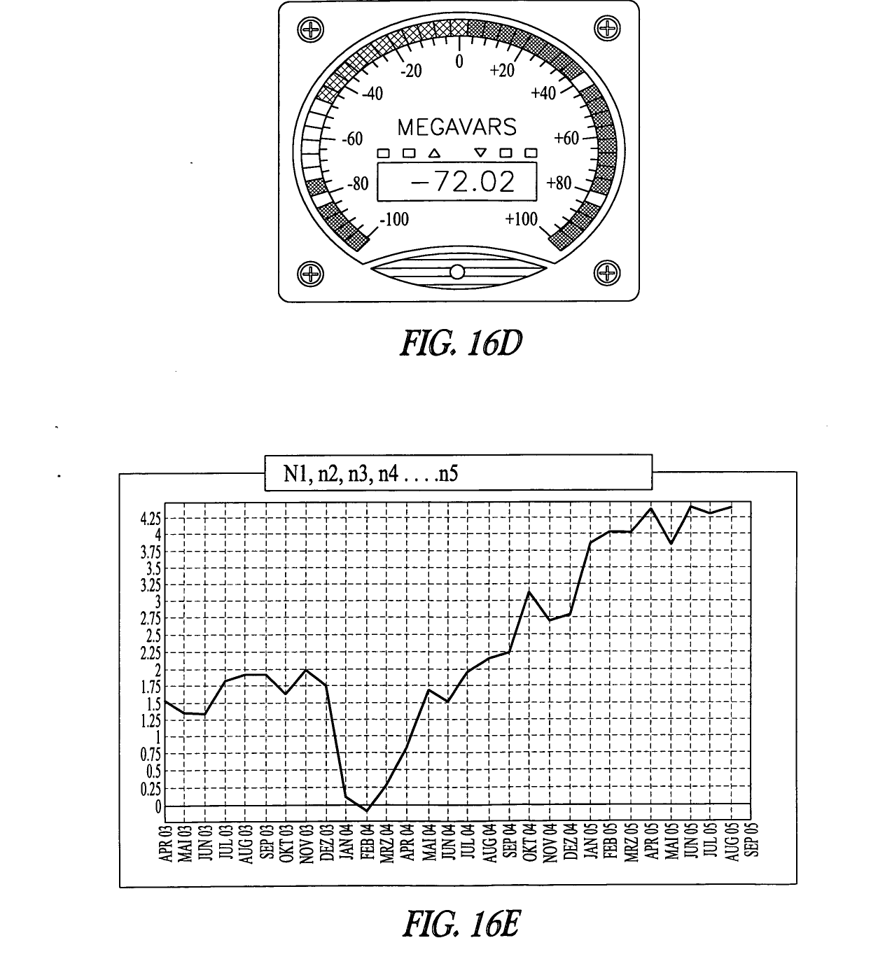

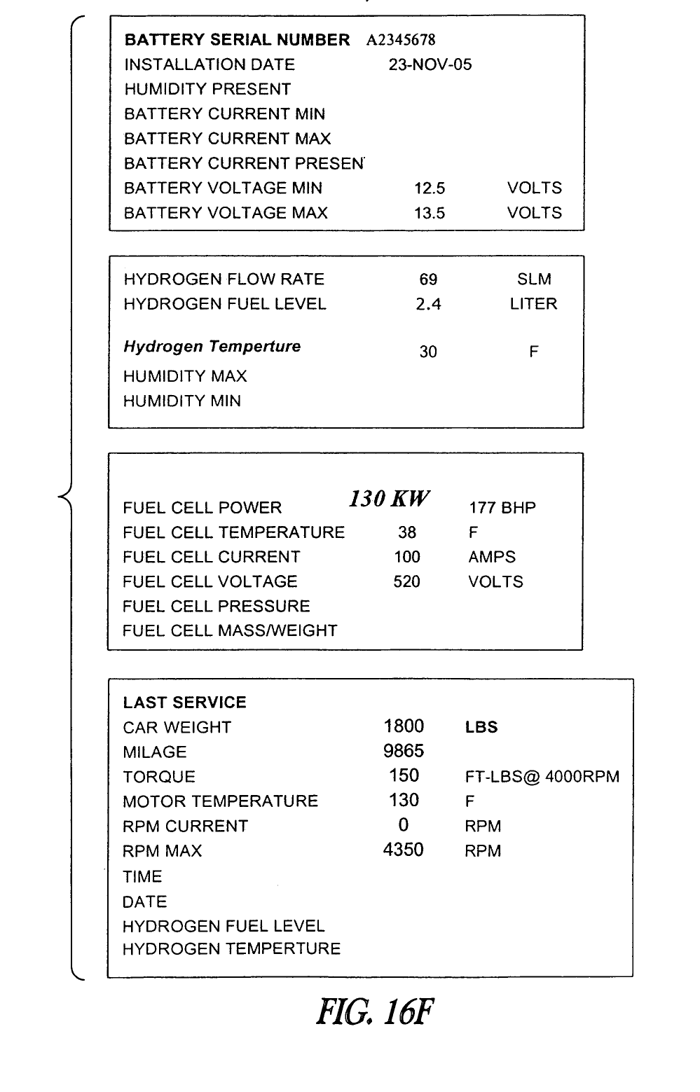

FIG. 1 illustrates one embodiment of a System Operational
Overview of the invention
FIG. 2 illustrates one embodiment of a Hardware Overview of the
Hydrogen Fuel Cell Vehicle (HFCV).
FIG. 3 illustrates one embodiment of a System Schematic of the
HFCV of the invention.
FIG. 4 illustrates one embodiment of Metal Hydride Canisters
usable in the HFCV of the invention.
FIG. 5 illustrates one embodiment of an H(2) Flow Controller
usable in the HFCV of the invention.
FIG. 6 illustrates one embodiment of a Convection Stack Hydrogen/
Air PEM Fuel Cell usable in the HFCV of the invention.
FIG. 7 illustrates one embodiment of a Motor Controller usable in
the HFCV of the invention.
FIGS. 8A and 8B illustrate one embodiment of a Motor and Gearbox
usable in the HFCV of the invention.
FIG. 9 illustrates one embodiment of a Console Display usable in
a system of the invention.
FIG. 10 illustrates a GPS Tracking module usable in the system of
the invention.
FIG. 11 illustrates an on On Board Computer usable in the HFCV of
the invention.
FIG. 12 illustrates a Display of the Vehicle Systems Performance
usable in the system embodiment of the invention.
FIG. 13 illustrates a schematic view of a system for wireless data
collection and up linking to a maintenance service center.
FIGS. 14A and 14B illustrate communication interface system
embodiment for the system of the invention.
FIGS. 15A and 15B illustrate embodiments of hydrogen leak detection
sensors usable in system embodiments of the invention.
FIGS. 16A through 16F illustrate display format embodiments usable
in system embodiments of the invention.

### DESCRIPTION

Although detailed embodiments of the invention are disclosed herein, it is to be understood that the disclosed embodiments are merely exemplary of the invention that may be embodied in various and alternative forms. Specific structural and functional details disclosed herein are not to be interpreted as limiting, but merely as a basis for teaching one skilled in the art to variously employ the wireless data collection from a hydrogen fuel cell vehicle and data transmission to a maintenance data center embodiments. Throughout the drawings, like elements are given like numerals.

One embodiment of the invention described herein includes a zero-emissions Hydrogen Fuel Cell Vehicle (HFCV) having a wireless mechanism for transmitting data from the fuel cell vehicle to a central data center, illustrated for one embodiment at 10 in FIG. 1. Another embodiment, illustrated at 12 in FIG. 9, includes a display system 14 for displaying status of the hydrogen fuel cell to a vehicle driver. One other embodiment for data collection and up linking of data in a wireless data collection mechanism from a vehicle powered with one or more hydrogen fuel cells and a maintenance service center is shown at 130 in FIG. 13.

Vehicles operating with Proton Exchange Membrane Fuel Cells (PEM) are described herein. However, it is understood that invention embodiments described herein are usable for other types of hydrogen fuel cells including alkaline, phosphoric acid, molten carbonate and solid oxide.

PEM fuel cell embodiments used in vehicle embodiments described herein include a solid ion exchange membrane made of a sulfonated Teflon-like material and are embedded with a platinum catalyst. Hydrogen gas flows to the fuel cell and is controlled by a gas flow controller. An increase in hydrogen gas results in higher voltage and current outputs from the fuel cell. Voltage and current measurements are made by an on-board computer and are then sent to a maintenance data center, as schematically shown in FIG. 3.

One HFCV hydrogen fuel cell vehicle described herein includes an on board computer that collects data and sends the collected data via wireless communications channels to a secure website or secure service center as shown in FIG. 1. For one embodiment the HFCV includes the following features:

### SYSTEM BLOCK DIAGRAM

HFCH Main Specifications

Vehicle: Fiero with PEM Fuel Cell

| | |
|---|---|
| Metric units | US units |

| | | | | |
|---|---|---|---|---|
| Dimensions | | | | |
| L | 4082 | mm | 160.7 | in |
| W | 1752 | mm | 68.9 | in |
| H | 1192 | mm | 46.9 | in |
| Weight | 1252.73 | kg | 3,092 | lb |

| | |
|---|---|
| Seating capacity | 2 persons |

Performance:

| | | |
|---|---|---|
| Max cruising range | 145 km | 90 mi |
| Maximum speed | 155 km/h | 96 mi/h |

Fuel cell stack:

| Name | Ovonic FC Stack | |
|---|---|---|
| Type | PEM electrolyte fuel cell | |
| Output | 45 kW | 61 hp |

Motor:

| Type | AC Induction | | | |
|---|---|---|---|---|
| Maximum output | 50 | kW | 109 | hp |
| Maximum torque | 90 | N-m | xxx | lbf |

Fuel:

| Type | Pure hydrogen | |
|---|---|---|
| Storage method | Metal hydride storage tanks | |
| Max. Storage pressure | 17.5 MPa | 2,500 psi |

Secondary battery:

| | |
|---|---|
| Type | Nickel-metal hydride (NiMH) |

Hardware Overview of the HFCV

The HFCV embodiment described herein includes a hydrogen fuel-cell vehicle that is based on the Pontiac Fiero chassis. The Pontiac chassis was selected because of its light weight and lower body mass. The chassis also supported a rear wheel drive transaxle which made it suitable, for a hydrogen conversion automobile. While a particular chassis is described herein, it is understood that other vehicle chassis are suitable for use.

All the hardware was installed at key locations throughout the chassis in a manner that considered the safety of the passengers, combined with ease of maintenance access. The vehicle's hydrogen fuel system was reliable, durable and user-friendly. FIG. 2 schematically illustrates a hardware overview of the components that are internal to the HFCV.

System Schematic of the HFCV

Hydrogen from a storage canister such as is shown at 40 in FIG. 4 feeds H(2) gas into a fuel-cell stack 42, shown in FIG. 5 and FIG. 6 via control of a H(2) gas flow controller 44, shown in FIG. 5. The hydrogen gas flow rate coming out of the storage canister 40 is controlled by the H(2) flow controller 44. The H(2) flow rate controller is connected to an on-board computer 46. When hydrogen reaches the fuel cell 42, it is combined with oxygen from the air. The chemical reactions of combining hydrogen and oxygen, generate electricity and produce water (H(2)O) as the by-product. The water is drained through the vehicle's tailpipe. A schematic of this process is shown in FIG. 3.

Electricity from the fuel-cell is sent to the Auxiliary Power Unit (APU) 48, shown in FIG. 3, where it is conditioned and sent to an electric motor 50, under the control of the Motor Controller, shown in one embodiment at 70 in FIG. 7. The electric motor 50 propels the vehicle forward via the transaxle that is connected to the motors' gearbox, shown for one embodiment at 80 in FIG. 8. A driver 82 controls the speed of the vehicle by an accelerator pedal that varies the speed of the electric motor.

An onboard computer 90 monitors the power, voltage, current, temperature, RPM, speed and H2 gas flow rate and displays the data to the driver on the display console. The collected data is also, combined with time, date and Global Position (GPS) data and sent via a wireless link to the maintenance control center. All the data is stored for future viewing at a secure data center.

Hydrogen Metal Hydride Canister

FIG. 4 illustrates some embodiments of metal hydride canisters 41, 43, and 45. The canisters 41 and 43 store hydrogen gas within a vehicle. While metal hydride and metal hydride canisters are described, it is understood that other forms of hydrogen storage are suitable for use in embodiments of the invention. The life of the metal hydride storage tank 41, 43 or 45 is directly related to the purity of the hydrogen it is storing. The alloys act as a sponge, which absorbs hydrogen, but it also absorbs any impurities introduced into the tank by the hydrogen. The result is the hydrogen released from the tank is extremely pure, but the tank's lifetime and ability to store hydrogen is reduced as the impurities are left behind and fill the spaces in the metal that the hydrogen once occupied.

Gas Leak Detection Sensors

Some embodiments of the HFCV include multiple sensors to detect hydrogen gas leaks. A tank 150, shown in FIG. 15A includes sensors A1 and A2 to detect possible gas leaks and both sensors A1 and A2 to confirm any gas leaks for tank 150. Where a leak is detected, a safety shut off valve disables the flow of hydrogen for tank 150 and sends a gas leak detected alert to the central computer.

For some embodiments, the hydrogen leak detectors use duel sensors to reduce false alarms to the driver. Where a leak is detected, the system outputs both display visual and audio alerts to the driver and to the maintenance center.

For embodiments having a second hydrogen tank, shown at 152 in FIG. 15B, multiple gas leak detection sensors are included. A second hydrogen storage tank 152 is automatically used when the hydrogen storage tank 150 has been determined to have a gas leak. The tank 152 includes sensors B1 and B2 for detecting possible gas leaks and both sensors B1 and B2 confirm any gas leaks for the tank 152. In case of a detected leak, a safety shut off valve disables the flow of hydrogen for tank 152 and sends a gas leak detected alert to the central computer. Similar redundant sensor arrangements are envisioned for embodiments with more than two hydrogen tanks.

H(2) Flow Controller A Metal Hydride Canister 41, 43 or 45, shown in FIG. 4 stores the hydrogen gas. The H(2) feeds into the gas flow controller 45. The hydrogen gas flow controller 45 controls the rate of the hydrogen coming out of the storage canister 41, 43, Or 45.

The hydrogen output flow rate is under the control of the on-board computer. A cable connects the H(2) flow rate controller to the on-board computer 46. The output of the H(2) flow controller is sent to the PEM Fuel Cell 42. The electricity produced by the PEM fuel Cell increases as the hydrogen gas flow rate is increased.

PEM FUEL CELL

Fuel cells are named or defined by their electrolyte, i.e.: phosphoric acid, molten carbonate, solid oxide, or proton exchange membrane.

There five basic types of fuels cells:

| | | |
|---|---|---|
| PEMFC | Proton Exchange Membrane | Fuel Cell |
| AFC | Alkaline | Fuel Cell |
| PAFC | Phosphoric Acid | Fuel Cell |
| MCFC | Molten Carbonate | Fuel Cell |
| SOFC | Solid Oxide | Fuel Cell |

In one embodiment, a PEM fuel cell is used in the HFCV vehicle design. PEM fuel cells have a solid ion exchange membrane made of a sulfonated Teflon-like material (which is the electrolyte), and are embedded with a platinum catalysts. FIG. 6 shows how a PEM fuel cell uses hydrogen and oxygen to convert to electrical power. The hydrogen gas flow to the fuel cell is controlled by the gas flow controller. An increase in hydrogen gas results in higher voltage and current outputs from the fuel cell. Voltage and Current measurements are made by the On-Board Computer and then sent to the maintenance data center.

APU (Auxiliary Power Unit)

The APU takes the power from the fuel cell and converts and distributes the power to the Motor controller and to the all the accessories such as head lights, brakes, and heater. System performance is monitored by the on-board computer.

Motor Controller

The motor controller shown at 70 in FIG. 7 is responsible for providing the motor with the required power to propel the HFCV forward or reverse. Driver inputs are sent to the Motor controller. The on board computer monitors the performance of the system.

Motor and Gear Box

One embodiment of the HFCV uses an AC induction motor and gearbox combined as one unit. The motor and gearbox are at the rear of the vehicle.

Specifications for the motor and gearbox assembly for one embodiment include the following.

Specifications

Specifications

| Peak Torque | 90 | Nm |
|---|---|---|
| Maximum Current | 280 | A rms |
| Continuous Torque | 21 | Nm |
| Continuous Power | 17 | kW |
| Peak Efficiency | 92.5% | |
| Peak Electrical Power | 50 | kW |
| At voltage of | 280 | Vdc |
| Nominal Motor Speed | 4k | rpm |
| Maximum Motor Speed | 12k | rpm |
| Weight of motor and gearbox | 65 | kg |
| Gearbox Ratio | 12:1 | |

Motor and Gearbox Specifications for one embodiment include the following:

$$\begin{matrix}MPH = \frac{RPM \times R ( Radius of tire )}{G 1 + G 2 + Co \text{-} Efficient Ds ( 168 )} \\ G 1 = gear ratio ( first ) \\ G 2 = gear ratio ( final ) \\ Ds = D 1 + D 2 \\ D 1 = Drag Coefficient \\ D 2 = Friction of the tires on pavement\end{matrix}$$

Accessories Include

Heater, Air Condition, radio

USER INPUTS include

Drive Controls

Acceleration,

Brakes

Cameras are included in some embodiments.

Console Display

FIG. 9 shows one console display embodiment as it would appear to the driver inside the HFCV automobile. Data is sent from the computer to the console display. In one embodiment, the console display includes hydrogen leak alert indicator and a readout that will inform the driver of the location and distance to the nearest maintenance center. Other embodiments are envisioned that would provide the maintenance center information audibly or via a graphical navigation system display.

Wireless Data Transmission

The collected vehicle performance data is transmitted wirelessly to a secure web site or the maintenance data center. Wireless transmission occurs via either the cellular telephone network or via IEEE 802.11 (Wi-Fi) hot spots.

GPS Capability

Global Positioning System (GPS), one embodiment of which is shown at 100 in FIG. 10, allows the HFCV to calculate the location of the vehicle on the earth anytime, in any weather, anywhere. GPS is accurate to within approximately 150 feet, but in practice accuracy is often far more precise, usually within 25 feet or less. Using the receiver, the HFCV-Beta can determine its location with great precision.

The Global Positioning System (GPS), formally known as the Navistar Global Positioning System, was primary designed for use by the U.S. and allied military forces. Today, GPS is also available for commercial applications. GPS receivers use satellites, each in its own orbit 11,000 nautical miles above the Earth to receive signals which are then translated to longitude and latitude coordinates. GPS tracking satellites are continuously monitored by ground stations located worldwide. The satellites transmit signals that can be detected by anyone with a GPS receiver.

The output from the GPS is combined with data from the on board computer. The HFCV uses the GPS receiver to time and location tag the temperature, power, current, voltage, Speed, RPM and other system parameters. A RS-232 cable is used to connect the GPS receiver to the on-board computer.

On Board Computer

The HFCV embodiment example described herein used a compact, low-power, low-cost, advanced communication computer, one embodiment of which is shown at 110 in FIG. 11, which is based on a 133 MHz 486 class processor. It has three 10/100 Mbit Ethernet ports, up to 64 Mbyte SDRAM main memory and uses a CompactFlash module for program and data storage. It can be expanded using a MiniPCI type III board and a low-power standard PCI board.

It has been optimized for use as a Firewall and VPN Router, but has the flexibility to take on a whole range of different functions as a communication motherboard. The board is designed for long life and low power. The mother board is housed in a small environmentally safe metal box.

Specifications for one embodiment are as follows:

100/133 MHz AMD ElanSC520
16-64 Mbyte SDRAM, soldered on board
1 Mbit BIOS/BOOT Flash
CompactFLASH Type I/II socket, 8 Mbyte FLASH to 4 Gbyte Microdrive
1-3 10/100 Mbit Ethernet ports, RJ-45
1 Serial port, DB9. (optional 2nd serial port)
Power LED, Activity LED, Error LED
Mini-PCI type III socket. (t.ex for optional hardware encryption.)
PCI Slot, right angle 3.3V only. (t.ex for optional WAN board.)
8 bit general purpose I/O, 14 pins header
Hardware watchdog
Board size 4.85″×5.7″
Power using external power supply is 6-20V DC, max 10 Watt
Option for 5V supply using internal connector
Operating temperature 0-60° C.
   Software:
comBIOS for full headless operation over serial port
PXE boot rom for diskless booting
Designed for FreeBSD, NetBSD, OpenBSD and Linux
Runs most real-time operating systems

One embodiment shown in FIGS. 14A and 14B, include a polling algorithm to identify wireless channels available.

While specific features of one on board computer are described, it is understood that other computer embodiments are suitable for use.

CENTRAL MAINTENANCE DATA CENTER

At the maintenance data center the data is displayed in numerical digits and charted in bar graph format, as shown for one embodiment in FIG. 12. Another display embodiment is shown in FIG. 16A-F.

Additionally, all the data is logged by calendar day and can be easily retrieved with point and click menus. Since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes, which come within the meaning and range of equivalency of the claims, are intended to be embraced therein.

What is claimed is:

1. A system for wireless data collection from a hydrogen fuel cell vehicle comprising:
(i) a vehicle that includes a fuel cell and an on-board computer;
(ii) transmitter for transmitting data from the on-board computer; and
(iii) wireless mechanism for receiving the data.

2. The system of claim 1, further comprising;
a mechanism for monitoring vehicle performance data.

3. The system of claim 2, wherein a mechanism for monitoring vehicle performance data monitors hydrogen gas flow rate.

4. The system of claim 2, wherein a mechanism for monitoring vehicle performance data monitors power, voltage, current, temperature, RPM, and speed.

5. The system of claim 2, further comprising;
a mechanism for display to the driver of monitored data.

6. The system of claim 1, further comprising;
a mechanism for receiving data sent wirelessly via a telephone cell tower.

7. The system of claim 1, further comprising;
a mechanism for receiving data sent wirelessly via a Wi-Fi wireless hot spot.

8. The system of claim 1, further comprising;
a maintenance data center.

9. The system of claim 8, further comprising;
a mechanism for receiving, storing, and displaying vehicle performance data.

10. The system of claim 1, further comprising;
a secure web site for receiving, storing, and displaying transmitted data.

11. The system of claim 1, further comprising;
a global positioning system (GPS).

12. Vehicle comprising a fuel cell, an on-board computer capable of monitoring variables affected by the performance of the fuel cell and a transmitter for transmitting the data.

13. The vehicle of claim 12, wherein the on-board computer monitors hydrogen gas flow rate.

14. The vehicle of claim 12, wherein the on-board computer monitors power, voltage, current, temperature, RPM, and speed.

15. The vehicle of claim 12, further comprising;
a mechanism for display to the driver of monitored variables.

16. The vehicle of claim 12, wherein the transmitter for transmitting data utilizes telephone cell towers.

17. The vehicle of claim 12, wherein the transmitter for transmitting data utilizes Wi-Fi wireless hot spots.

18. The vehicle of claim 12, further comprising;
a global positioning system (GPS).

19. The vehicle of claim 18, wherein the on-board computer is capable of receiving and transmitting data from the GPS including: time, date, and location.

20. A system for detecting hydrogen leaks in a vehicle powered by hydrogen, comprising:
(i) at least one sensor for detecting hydrogen; and
(ii) a transmitter for transmitting data from the sensor.

21. The system of claim 20, further comprising;
at least one sensor on each hydrogen source (tank).

22. The system of claim 20, further comprising;
a mechanism for alerting the driver if a leak is detected.

23. The system of claim 20, further comprising;
a mechanism for alerting the maintenance center if a leak is detected.

24. The system of claim 20, further comprising;
a mechanism for indicating to the driver the location of and distance to the nearest maintenance center.

25. A method for alerting the driver of a vehicle powered by hydrogen of any hydrogen leaks, consisting of:
(i) monitoring at least one sensor for detecting hydrogen on each hydrogen source on-board the vehicle; and
(ii) creating an alert if a leak is detected.

26. A method for alerting the maintenance center for vehicles powered by hydrogen of any hydrogen leaks, consisting of:
(i) monitoring at least one sensor for detecting hydrogen on each hydrogen source on-board the vehicle;
(ii) creating an alert if a leak is detected; and
(iii) transmitting the alert to the maintenance center.

27. A method for detecting and containing a hydrogen leak in a vehicle powered by hydrogen, consisting of:
(i) monitoring at least one sensor for detecting hydrogen on each hydrogen source; and
(ii) automatically activating a safety shut off valve if a leak is detected.

28. A system for collecting, storing, and displaying data transmitted from a hydrogen fuel cell vehicle comprising:
(i) a mechanism for transmitting data from at least one hydrogen fuel cell vehicle;
(ii) a mechanism for collecting the data transmitted from at least one hydrogen fuel cell vehicle;
(iii) a mechanism for storing the data collected from at least one hydrogen fuel cell vehicle; and
(iv) a mechanism for displaying the data collected from at least one hydrogen fuel cell vehicle.

29. A method for collecting, storing, and displaying data from a hydrogen fuel cell vehicle including:
(i) utilizing an on-board computer to monitor and collect performance data;
(ii) utilizing a wireless transmission mechanism for transmitting the collected performance data;
(iii) storing transmitted data on computer readable media; and
(iv) displaying collected performance data in graphic and/or numeric forms.
